(19) United States
(12) Patent Application Publication
(10) Pub. No.: US 2023/0133370 A1
(43) Pub. Date: May 4, 2023

(54) HAIR CUT TRAINING DEVICE

(71) Applicant: Emil Gyula Kleinfeller, Tappen (CA)

(72) Inventor: Emil Gyula Kleinfeller, Tappen (CA)

(21) Appl. No.: 17/979,663

(22) Filed: Nov. 2, 2022

Related U.S. Application Data
(60) Provisional application No. 63/274,861, filed on Nov. 2, 2021.

(51) Int. Cl. A45D 44/14; G09B 25/00

(52) U.S. Cl. CPC A45D 44/14; G09B 25/00

(57) ABSTRACT

A system and method for training a haircut wherein the system comprises a body shaped to correspond to a head of a person, a plurality of rigid members extending substantially radially from the body and at least one flexible member extending between at least two of the rigid members. The method comprises slidably locating at least one flexible member extending between at least two of the rigid members at a position selected to indicate the length at which hair is to be cut at that location.

### BACKGROUND

### 1. Technical Field

This disclosure relates generally to cutting hair and in particular to a method and apparatus for training people how to cut hair to a particular hairstyle.

### 2. Description of Related Art

Training new hairdressers to cut particular styles is difficult process to conduct on a wide scale and with consistent and repeatable results. Most commonly, such training or teaching is conducted through demonstration and observation of a teacher on a person or a model. Such modeling however may be prone to introducing variation into the teaching process.

Previous attempts to standardize the teaching process have utilized pictures or videos that, while consistent from use to use, are only two-dimensional and therefore lack the ability for a student to view from all angles.

Furthermore, attempts have been made to provide a three dimensional model for teaching hair cut styles. In particular, some designs have provided indicators, which are positionable on a model of a head that indicate a direction and length of the cut of the hair in that region. Such designs however, do not permit adjustment of the length of the cut other than by permanently cutting the length of the members. Such designs also rely on the skill of a person to locate the cut indicators at the correct location. Examples of such designs may be found, for example in U.S. Pat. No. 4,370,137 to Herzig et al.

### SUMMARY OF THE DISCLOSURE

According to a first embodiment, there is disclosed a system system for training a haircut comprising a body shaped to correspond to a head of a person, a plurality of rigid members extending substantially radially from the body and at least one flexible member extending between at least two of the rigid members.

The plurality of rigid members may be secured to the exterior surface of the body. The plurality of rigid members may be embedded within the body through an exterior surface thereon. The plurality of rigid member may be secured within the body within a region selected to correspond to a hair growth region of the person.

The rigid members may comprise sticks. The rigid members may include indicators thereon for different hair cut styles at which the flexible members are to be located.

The indicators may be at distances from the surface of the body corresponding to the desired hair length for a pre selected haircut. The system may further comprise a plurality of indicator on each of the plurality of rigid members, wherein each of the plurality of indicators corresponds to a unique haircut.

The flexible members may be slidably movable on the rigid members. The flexible member may include a loop surrounding each of the plurality of rigid members. The flexible members may include an indicator operable to be located by a camera for scanning into a computer simulator.

According to a further embodiment, there is disclosed a method for training a haircut comprising providing a body shaped to correspond to a head of a person, extending a plurality of rigid members substantially radially from the body and slidably locating at least one flexible member extending between at least two of the rigid members at a position selected to indicate the length at which hair is to be cut at that location.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of a system for teaching a haircut according to a first embodiment of the present disclosure.

FIG. 2 is a detailed perspective view of two rigid members and a flexible member of the apparatus of FIG. 1 at one of a plurality of positions.

FIG. 3 is an illustration of a screen shot of a computer control system for use in the system of FIG. 3.

### DETAILED DESCRIPTION

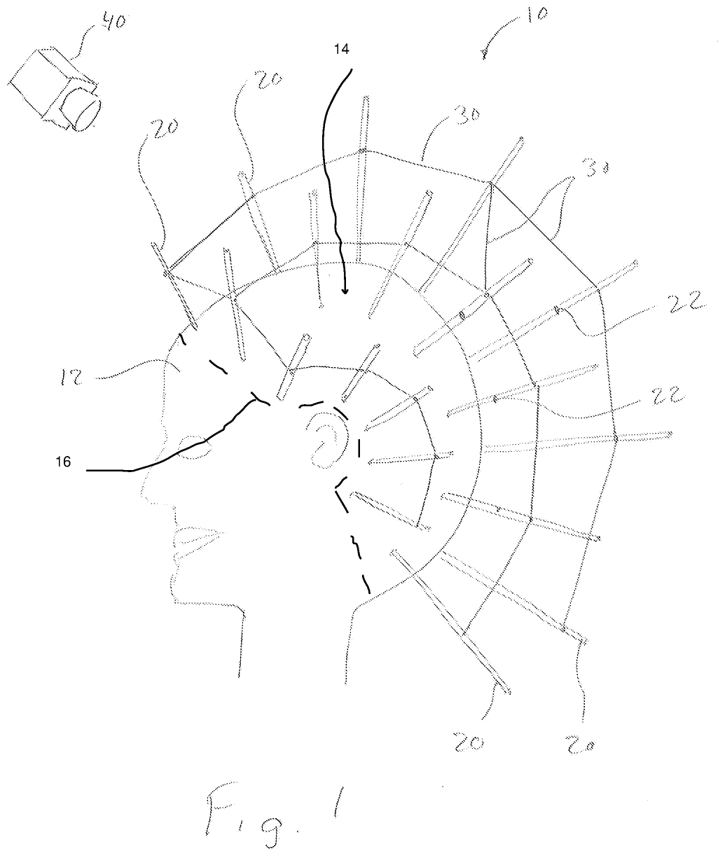

Aspects of the present disclosure are now described with reference to exemplary apparatuses, methods and systems. Referring to FIG. 1, an exemplary apparatus for teaching how to cut hair according to a particular style according to a first embodiment is shown generally at 10. They system comprises a model head 12 having a plurality of radially extending rigid members 20 extending radially outwardly from a surface 14 thereof. and a plurality of flexible members 30 extending therebetween. The rigid members 20 are locate within a region on the body generally indicated at 16 corresponding to a region in which hair grows on a person.

The rigid members 20 may be formed of sticks or rods and may be inserted into or otherwise embedded within the model head 12. As illustrated in FIG. 1, the rigid members may be extend substantially perpendicularly or radially from the surface of the model head 12, however other angular orientations may also be utilized to correspond to a desired orientation of the hair to be cut at that location. The rigid members 20 may include indicators 22 at one or more locations therealong corresponding to a location to which the flexible members are to be located. Optionally, the indicators may indicate a length, such as in any suitable units, which may be utilized with a guide to position the flexible members at the indicated locations. Each rigid member 20 may include a plurality of indicators corresponding to a different hair style. In particular, the plurality of indicators across each of the rigid members may be grouped to each other such that each rigid member includes one indicator corresponding to that group so that a user may move the flexible members to each of the indicators of that group for the desired hair cut. The indicators may be grouped by any known means including color coding, numbering or other symbols.

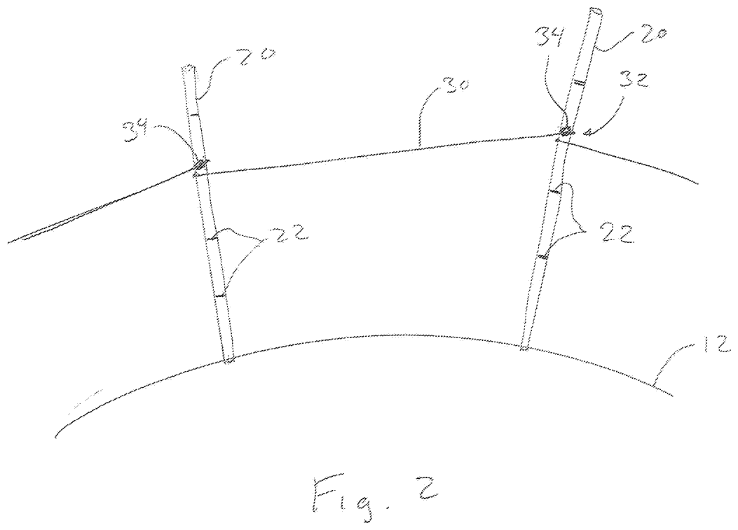

The flexible members 30 may be formed of string, elastic or any other suitable flexible material. The flexible members may be secured to the individual rigid members in a predefined direction by tying or looping, as indicated at 32 in FIG. 2, around the rigid members as illustrated in FIG. 1. The flexible members may optionally include an indicator 34, which is operable to be scanned or captured by a camera relative to the model head 12 for use in a program as described further below. In particular, the indictor, as illustrated in FIG. 2, may comprise a reflective or otherwise colored body, which is detectable by a scanner or camera.

In operation, a user may position the flexible members 30 at the indicated positions and between the indicated rigid members 20 corresponding to a desired haircut. In particular, the flexible members 30 indicate to a student the direction and length to cut the lock of hair at that location on the head to achieve the desired haircut. In such a manner, the student has a 3 dimensional model that they can view from any desired angle as they learn. A teacher may also thereafter move the flexible members to different locations and lengths on the rigid members to demonstrate how to cut a different haircut.

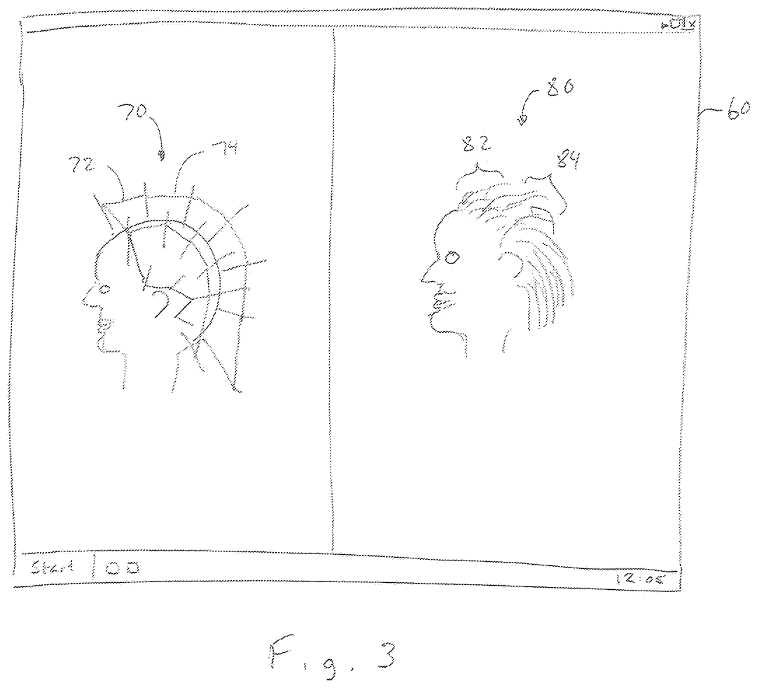

Optionally as illustrated in FIG. 1, a camera 40 may be provided operable to scan the model head 12 and in particular the indicators 34 so as to input these dimensions into a computer model. As illustrated in FIG. 3, software program 60 operated on a computing device may receive the scanned image as provided by the camera 40 and display a representation of such scanned model 70 on the screen for presentation to a user. Such scanned model may then be rotated, zoomed or other wise viewed from any desired direction. It will be appreciated that such scanned computer image may then also be distributed to other users through any desired communication medium for them to utilized in learning the indicated haircut.

Optionally, the software program 60 may be predict and illustrate a simulated hair cut 80 based upon the scanned location of cut lines represented by the flexible members. In particular, with reference to FIG. 1, the program may be configured to utilize the length of a first lock of hair 72 which is cut as indicated to represent how such lock 82 would appear on a user's head. Second and subsequent cuts 72 and so forth may be similarly modeled to subsequent locks 84 and so forth. The simulated haircut 80 may be displayed on a monitor in either a static, multi view representation, or as a dynamic rotatable and manipulatable image as are known or displayed as a holographic representation by one or more holographic cameras or display units.

While specific embodiments have been described and illustrated, such embodiments should be considered illustrative only and not as limiting the disclosure as construed in accordance with the accompanying claims.

What is claimed is:

1. A system for training a haircut comprising:
a body shaped to correspond to a head of a person;
a plurality of rigid members extending substantially radially from the body; and
at least one flexible member extending between at least two of the rigid members.

2. The system of claim 1 wherein the plurality of rigid members are secured to the exterior surface of the body.

3. The system of claim 2 wherein the plurality of rigid members are embedded within the body through an exterior surface thereon.

4. The system of claim 3 wherein the plurality of rigid member are secured within the body within a region selected to correspond to a hair growth region of the person.

5. The system of claim 1 wherein the rigid members comprise sticks.

6. The system of claim 1 wherein the rigid members include indicators thereon for different hair cut styles at which the flexible members are to be located.

7. The system of claim 6 wherein the indicators are at distances from the surface of the body corresponding to the desired hair length for a pre selected haircut.

8. The system of claim 6 further comprising a plurality of indicator on each of the plurality of rigid members, wherein each of the plurality of indicators corresponds to a unique haircut.

9. The system of claim 1 wherein the flexible members are slidably movable on the rigid members.

10. The system of claim 9 wherein the flexible member includes a loop surrounding each of the plurality of rigid members.

11. The system of claim 1 wherein the flexible members includes an indicator operable to be located by a camera for scanning into a computer simulator.

12. A method for training a haircut comprising:
providing a body shaped to correspond to a head of a person;
extending a plurality of rigid members substantially radially from the body; and
slidably locating at least one flexible member extending between at least two of the rigid members at a position selected to indicate the length at which hair is to be cut at that location.
